(19) United States
(12) Patent Application Publication
(10) Pub. No.: US 2025/0147663 A1
(43) Pub. Date: May 8, 2025

(54) APPARATUS AND METHOD FOR PROCESSING COPY-ON-WRITE SUPPORTING FORK IN MEMORY DISAGGREGATION SYSTEM

(71) Applicant: ELECTRONICS AND TELECOMMUNICATIONS RESEARCH INSTITUTE, Daejeon (KR)

(72) Inventors: Chang-Dae KIM, Daejeon (KR); Kwang-Won Koh, Daejeon (KR); Tae-Hoon Kim, Daejeon (KR); Eun-Ji Pak, Daejeon (KR); Yeon-Jeong Jeong, Daejeon (KR)

(73) Assignee: ELECTRONICS AND TELECOMMUNICATIONS RESEARCH INSTITUTE, Daejeon (KR)

(21) Appl. No.: 18/935,895

(22) Filed: Nov. 4, 2024

(30) Foreign Application Priority Data
Nov. 8, 2023 (KR) 10-2023-0153807
Aug. 12, 2024 (KR) 10-2024-0107441

(51) Int. Cl. G06F 3/06

(52) U.S. Cl. CPC G06F 3/0608; G06F 3/0659; G06F 3/067

(57) ABSTRACT

Disclosed herein is an apparatus and method for processing write-on-copy for supporting a fork in a memory disaggregation system. The method includes, when a child process is generated in the event of a fork, processing the fork by copying a page table for disaggregated memory of a parent process to the child process and setting write protection on a page of the disaggregated memory; and processing write access to the write-protected page. Processing the write access may use at least one of a first handler corresponding to access to the write-protected page mapped to the page table, or a second handler corresponding to the write access to the write-protected page that is not mapped to the page table, or a combination thereof.

### CROSS REFERENCE TO RELATED APPLICATIONS

This application claims the benefit of Korean Patent Applications No. 10-2023-0153807, filed Nov. 8, 2023, and No. 10-2024-0107441, filed Aug. 12, 2024, which are hereby incorporated by reference in their entireties into this application.

### BACKGROUND OF THE INVENTION

### 1. Technical Field

The disclosed embodiment relates to Copy-on-Write technology for quickly processing a process fork of an application in a memory disaggregation system.

### 2. Description of the Related Art

In an existing computing system, an application generates multiple processes by forking a process and is run in such a way that the respective processes simultaneously process different tasks. Here, the application may generate the multiple processes from a single process through an operation called ‘fork’, in which case the process to be forked is referred to as a parent process and the process generated by forking is referred to as a child process.

The child process inherits all the context of the parent process, including memory. That is, the child process may share the memory data being used by the parent process by inheriting the same. This may be implemented using the following two methods.

The first method is to copy all the memory pages being used by the parent process and provide the same to the memory area used by the child process.

The second method is to set write protection on memory pages and allow the parent and child processes to access and read the same memory area by sharing the same. Then, when writing to the memory area is performed, a page fault is triggered to copy the corresponding page to an area for the child process such that the child process uses the copied data.

In the first method, when a fork is processed, it is necessary to copy all of the pages of the parent process, which causes a lot of fork latency. In contrast, the second method has an advantage in which the use of Copy-on-Write (CoW) minimizes the latency of a fork, so CoW is usually used in existing computing systems.

However, in a disaggregated memory environment, the situation may be different from that of the existing computing systems. In the disaggregated memory environment, local memory and remote memory are used together, whereby a greater amount of memory resources than the memory amount of a host may be provided. When an application or container runs in such a disaggregated memory environment, memory pages may reside in the remote memory, and because the memory pages may be managed in units of blocks as well as in units of memory pages, fork implementation may be more complicated.

Therefore, when a fork is performed in a disaggregated memory environment, the first method, which copies all of the memory pages used by a parent process, is usually used, but this may lead to the following problems.

First, when a page in remote memory is copied, it is necessary to load the page into local memory, copy the page, and send the same back to the remote memory. Here, due to a limit on the local memory, swapping may occur frequently.

Also, because all pages are copied when a fork is performed, the latency of the fork is very high.

Finally, because all pages are copied when a fork is performed, data that is highly likely not to be actually used is also copied, which may waste memory.

### SUMMARY OF THE INVENTION

An object of the disclosed embodiment is to support Copy-on-Write (CoW) when a new process is forked in an application or container in a memory disaggregation system.

A method for processing copy-on-write for supporting a fork in a memory disaggregation system according to an embodiment includes, when a child process is generated in the event of a fork, processing the fork by copying a page table for disaggregated memory of a parent process to the child process and setting write protection on a page of the disaggregated memory; and processing write access to the write-protected page. Processing the write access may use at least one of a first handler corresponding to access to the write-protected page mapped to the page table, or a second handler corresponding to write access to the write-protected page that is not mapped to the page table, or a combination thereof.

Here, the page of the disaggregated memory may be set to an active state or an inactive state depending on whether the page is mapped to a process when the page is stored in local memory, and may be set to a remote state when the page is stored in remote memory.

Here, processing the write access using the first handler may comprise, when the write-protected page is mapped to a write access process and other processes, setting a page copied from the write-protected page to the active state and assigning write permission on the copied page to the write access process.

Here, processing the write access using the first handler may comprise, when the write-protected page is mapped only to a write access process, changing the write-protected page to the active state and assigning write permission on the write-protected page to the write access process, and may further comprise, when the write-protected page is stored also in the remote memory, changing the write-protected page stored in the remote memory to the remote state; and when the write-protected page is stored only in the local memory, copying a page from the write-protected page and setting the copied page to the inactive state.

Here, processing the write access using the second handler may comprise, when the write-protected page is mapped to a process other than a write access process, setting a page copied from the write-protected page to the active state and assigning write permission on the copied page to the write access process.

Here, processing the write access using the second handler may comprise, when the write-protected page is not mapped to any process and is stored in the local memory, changing the write-protected page to the active state and assigning write permission on the write-protected page to a write access process, and may further comprise, when the write-protected page is stored also in the remote memory, changing the write-protected page stored in the remote memory to the remote state; and when the write-protected page is stored only in the local memory, copying a page from the write-protected page and setting the copied page to the inactive state.

Here, processing the write access using the second handler may comprise, when the write-protected page is not mapped to any process and is stored in the remote memory, setting a page in the local memory that is copied from the write-protected page to the active state, assigning write permission on the copied page to a write access process, setting the write-protected page stored in the remote memory to the remote state, and setting write protection thereon.

Here, an apparatus for processing copy-on-write for supporting a fork in a memory disaggregation system includes memory in which at least one program is recorded and a processor for executing the program. When a child process is generated in the event of a fork, the program may process the fork by copying a page table for disaggregated memory of a parent process to the child process and setting write protection on a page of the disaggregated memory, and when processing write access to the write-protected page, the program may use at least one of a first handler corresponding to access to the write-protected page mapped to the page table, or a second handler corresponding to the write access to the write-protected page that is not mapped to the page table, or a combination thereof.

Here, the page of the disaggregated memory may be set to an active state or an inactive state depending on whether the page is mapped to a process when the page is stored in local memory, and may be set to a remote state when the page is stored in remote memory.

Here, when the write-protected page is mapped to a write access process and other processes, the first handler may set a page copied from the write-protected page to the active state and assign write permission on the copied page to the write access process.

Here, when the write-protected page is mapped only to a write access process, the first handler may change the write-protected page to the active state and assign write permission on the write-protected page to the write access process, when the write-protected page is stored also in the remote memory, the first handler may change the write-protected page stored in the remote memory to the remote state, and when the write-protected page is stored only in the local memory, the first handler may copy a page from the write-protected page and set the copied page to the inactive state.

Here, when the write-protected page is mapped to a process other than a write access process, the second handler may set a page copied from the write-protected page to the active state and assign write permission on the copied page to the write access process.

Here, when the write-protected page is not mapped to any process and is stored in the local memory, the second handler may change the write-protected page to the active state and assign write permission on the write-protected page to a write access process, when the write-protected page is stored also in the remote memory, the second handler may change the write-protected page stored in the remote memory to the remote state, and when the write-protected page is stored only in the local memory, the second handler may copy a page from the write-protected page and set the copied page to the inactive state.

Here, when the write-protected page is not mapped to any process and is stored in the remote memory, the second handler may set a page in the local memory that is copied from the write-protected page to the active state, assign write permission on the copied page to a write access process, set the write-protected page stored in the remote memory to the remote state, and set write protection thereon.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 illustrates a method of copying all memory pages in the event of a fork in a disaggregated memory environment;

FIG. 2 is an exemplary view for explaining a method for processing copy-on-write for supporting a fork in a memory disaggregation system according to an embodiment;

FIG. 3 is a schematic configuration diagram of a memory disaggregation system according to an embodiment;

FIG. 4 is a flowchart for explaining a method of using a first handler to process copy-on-write for supporting a fork in a memory disaggregation system according to an embodiment;

FIGS. 5 and 6 are flowcharts for explaining a method of using a second handler to process copy-on-write for supporting a fork in a memory disaggregation system according to an embodiment; and

FIG. 7 a view illustrating a computer system configuration according to an embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

In the present specification, each of expressions such as “A or B”, “at least one of A and B”, “at least one of A or B”, “A, B, or C”, “at least one of A, B, and C”, and “at least one of A, B, or C” may include any one of the items listed in the expression or all possible combinations thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

Hereinafter, embodiments of the present disclosure will be described in detail with reference to the accompanying drawings. In the following description of the present disclosure, the same reference numerals are used to designate the same or similar elements throughout the drawings, and repeated descriptions of the same components will be omitted.

When an application or container is executed in a memory disaggregation system environment, multiple new processes generated from a single process are run. In order to generate such new processes, a fork is used. However, unlike existing systems, a disaggregated memory environment is configured to use remote memory, so there is a difference in page management in the event of a fork.

In the existing memory disaggregation system environment, all pages used by a parent process are copied in the event of a fork.

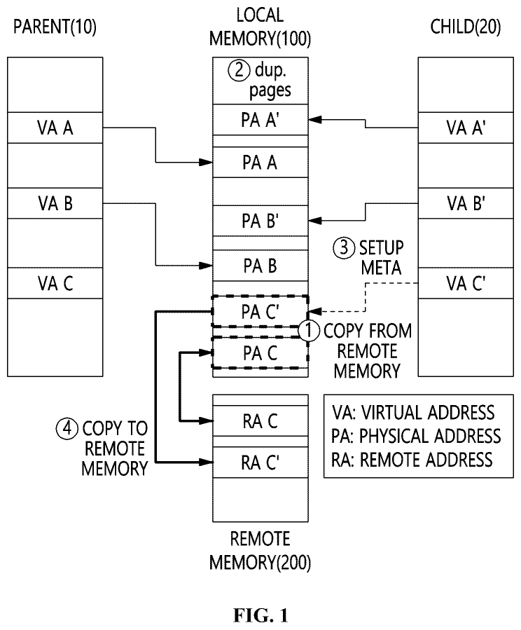

FIG. 1 is an exemplary view for explaining a method of copying all memory pages in the event of a fork in a memory disaggregation system.

Referring to FIG. 1, when a parent process 10 performs a fork, a child process 20 is generated, and all of the pages used by the parent process 10 are copied based on the page table of the parent process 10 to allow the child process 20 to manage data.

However, in this case, the latency of the fork is increased even in the existing system, and memory waste may occur because the child process 20 copies all of the data of the parent process 10 and uses the copied data.

This problem may be worse in a memory disaggregation system environment.

That is, because data may reside in remote memory 200, a page in the remote memory 200 should also be copied when data is copied.

When new data is generated, the child process 20 is required to remap the new data, but if the new data is present in the remote memory 200, metadata for a remote link is generated, whereby memory page mapping for the fork is completed.

Here, the process of copying the page present in the remote memory 200 may be implemented whereby the memory disaggregation system performs communication using a Remote Direct Memory Access (RDMA) protocol and copies the page from the system of a remote node using two-sided RDMA. That is, a host node may request the remote node to copy the corresponding memory page and may generate metadata by receiving information about the corresponding page.

However, many memory disaggregation systems use one-sided RDMA for access to remote memory by a host. This is because one-sided RDMA supports faster remote memory access than two-sided RDMA and because there is no interference from the CPU of the remote node.

However, using one-sided RDMA to copy a remote memory page requires fetching data from the remote memory 200 to local memory 100 ((1), copying the data ((2), setting metadata on the corresponding page ((3)), and sending the data back to the remote memory (4)), as illustrated in FIG. 1, so performance may be degraded.

Accordingly, an embodiment proposes an apparatus and method for processing copy-on-write for supporting a fork in a memory disaggregation system.

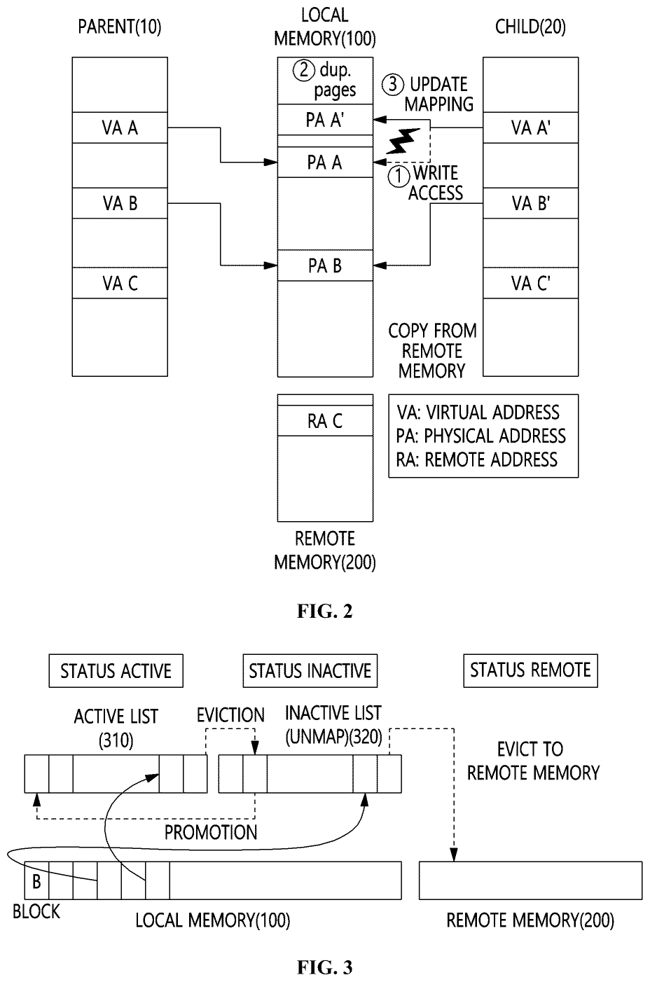

FIG. 2 is an exemplary view for explaining a method for processing copy-on-write for supporting a fork in a memory disaggregation system according to an embodiment.

Referring to FIG. 2, in the method for processing Copy-on-Write (CoW) for supporting a fork in a memory disaggregation system according to an embodiment, when a child process 20 is generated by copying a parent process 10 in the event of a fork, the page table of the parent process 10 is copied to enable the child process 20 to view the same pages, write protection is set on all pages, and data is not copied.

Accordingly, the parent process 10 and the child process 20 share the same pages.

However, when the parent process 10 or the child process attempts write access to the page, a page fault occurs due to the write protection set on the page.

In order to handle the page fault, the corresponding page is copied, and the page table (mapping) is updated to allow each of the parent process 10 and the child process 20 to access only the data written thereby.

For example, when write access to memory corresponding to PA A by the child process 20 occurs (\textcircled{1}), PA A′ is generated by copying ‘PA A’ (\textcircled{2}), and the page table (mapping) may be updated (\textcircled{3}) such that the child process 20 is allowed to access only PA A′, which is the data written thereby, as illustrated in FIG. 2.

Meanwhile, for a page stored in remote memory 200, metadata held by the parent process 10 is copied to share the corresponding remote memory page, and when access to the remote memory page by a process actually occurs, the corresponding data is fetched from the remote memory 200.

Here, after the data is fetched, the metadata on the remote memory 200 is deleted such that processes other than the process accessing the remote memory page can access the data as it was at the time of the fork. When CoW is supported in the memory disaggregation system in this manner, not only the cost of memory copying but also the total memory usage may be reduced.

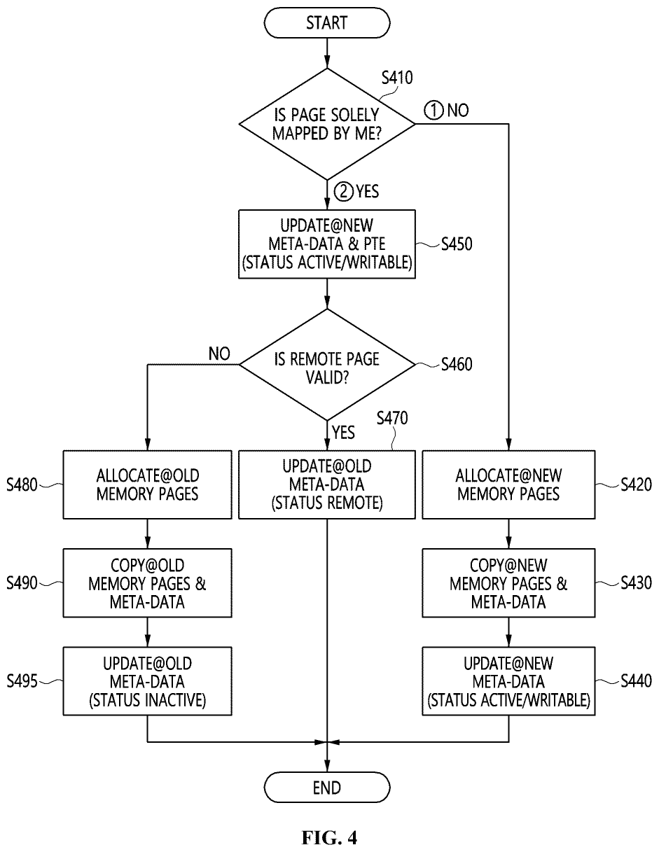

FIG. 3 is a schematic configuration diagram of a memory disaggregation system according to an embodiment.

Referring to FIG. 3, the memory disaggregation system according to an embodiment may be implemented by including local memory 100 of a host and remote memory 200 of a remote node.

Here, according to an embodiment, the local memory 100 may be managed using two LRU (Least Recently Used) lists including an active list 310 and an inactive list 320.

Here, the active list 310 and the inactive list 320 may be used to distinguish between frequently used memory pages (referred to as “memory blocks” hereinbelow) and infrequently used memory blocks.

That is, when the capacity of the local memory 100 of the host runs out, part of the data that is less frequently used is transferred to the remote memory 200, whereby the capacity of the local memory 100 is secured.

Conversely, when data in the remote memory 200 is accessed, the corresponding memory block is fetched again into the local memory 100 of the host and placed in the active list 310.

Also, the page corresponding to the infrequently used data in the inactive list 320 is present in the local memory 100 but is unmapped from the page table.

Here, the state of each memory block may be categorized and represented as ‘active’, ‘inactive’, or ‘remote (remote memory)’, corresponding to the above-mentioned lists.

Here, the active list and the inactive list may be an embodiment for implementing the active and inactive states of the memory block. That is, various other embodiments for implementing the active and inactive states of the block may be possible.

That is, when a memory block is in the active state, this indicates that the memory block is mapped to a process, when a memory block is in the inactive state, this indicates that the memory block is not mapped to a process but is present in the local memory 100, and when a memory block is in the remote state, this indicates that the memory block is present in the remote memory 200, rather than the local memory 100.

In order to support CoW in the above-described memory disaggregation system, it is necessary to know when the system performs writing to a write-protected page.

When write access to the write-protected page is processed according to an embodiment, a first handler corresponding to access to a write-protected page mapped to the page table and a second handler corresponding to write access to a write-protected page that is not mapped to the page table may be used. Here, the first handler may be a memory management notifier (mmu_notifier), and the second handler may be a write page fault handler.

In the memory disaggregation system, a page stored in the remote memory 200 is not mapped to the page table, so a page fault occurs. In this case, the second handler intervenes in handling the page fault, and the page stored in the remote memory 200 is moved to the local memory 100 such that the page can be accessed. Here, when the page fault results from write access, it may be checked whether write protection is set on the page.

On the other hand, when the page is stored in the local memory 100 in the memory disaggregation system, the page is mapped to the page table, so the page fault may be handled in a different manner. In this case, the content of the page table is changed in the CoW process, and the relevant mmu_notifier may be registered, so the first handler may intervene in handling the page fault for the write-protected page.

Meanwhile, in the method for processing CoW in a memory disaggregation system according to an embodiment, a first page (@old) is a write-protected page, and a second page (@new) may be defined as a page newly allocated to a process performing writing through CoW.

In an existing general system, the first page (@old) is mapped to and shared in the address space of a write access process, which performs writing, and other processes. However, in a memory disaggregation system, the first page (@old) is unmapped from the address spaces of all processes when it is moved to the remote memory 200, and when the first page (@old) is moved from the remote memory 200 back to the local memory 100, the first page (@old) is mapped only to the address spaces of processes accessing the memory.

Therefore, with regard to the mapping of the first page (@old), various cases may exist as shown in Table 1 below.

TABLE 1
\textcircled{1} the first page (@old) is mapped to and shared in the address spaces of
the process performing writing and other processes.
\textcircled{2} the first page (@old) is mapped only to the process performing
writing.
\textcircled{3} the first page (@old) is mapped only to processes other than the
process performing writing.
\textcircled{4} the first page (@old) is present in the local memory without being
mapped to any process.
\textcircled{5} the first page (@old) is stored only in the remote memory.

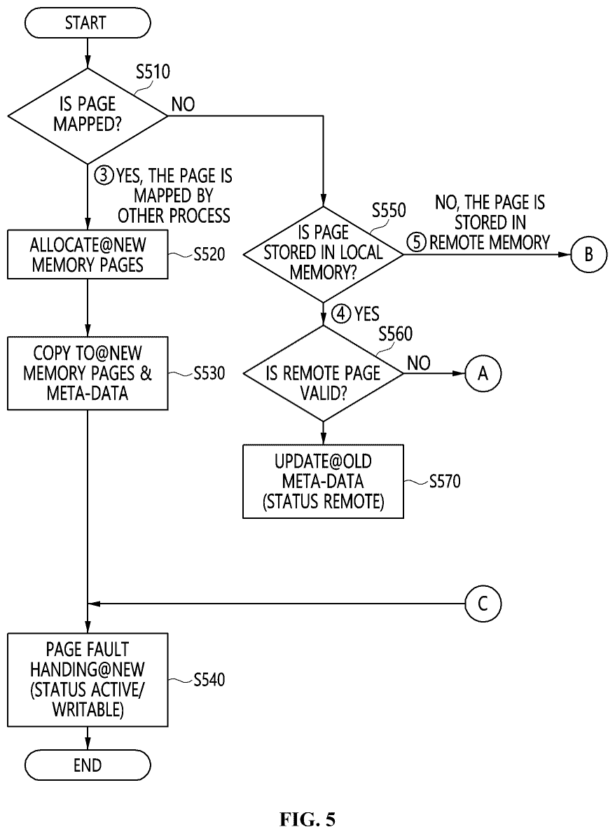

For the above-described five cases, the method for processing copy-on-write for supporting a fork in a memory disaggregation system according to an embodiment will be described in detail with reference to FIGS. 4 to 6. In the cases \textcircled{1} and \textcircled{2} in Table 1, the first page (@old) is mapped to the process performing writing, so these cases may be handled by using the first handler for handling access to a write-protected page.

FIG. 4 is a flowchart for explaining a method of using a first handler to process copy-on-write for supporting a fork in a memory disaggregation system according to an embodiment.

Referring to FIG. 4, when it is determined at step S410 that the first page (@old) is mapped to the process performing writing and other processes (the case \textcircled{1} in Table 1), new memory is allocated for a second page (@new) at step S420, the existing memory block and metadata are copied to the second page (@new) at step S430, the copied new memory is mapped to the process performing writing, and write permission is assigned to the process performing writing at step S440, whereby the CoW process is handled. Here, the state of the metadata may be updated to ‘ACTIVE’ because of the mapping to the page table at step S440.

Meanwhile, when it is determined at step S410 that the first page (@old) is mapped only to the process performing writing (the case \textcircled{2} in Table 1), the process performing writing continues to use data in the local memory.

To this end, write permission (‘WRITABLE’) on the second page (@new) is assigned to the page table entry of the process performing writing, and the state of the page in the memory disaggregation system is set to ‘ACTIVE’ at step S450. That is, it is placed in the active list in the LRU chain.

Here, the data at the corresponding time should be saved for other processes that share the first page (@old).

Here, when the existing corresponding block is stored in remote memory at step S460, the state of the first page (@old) is changed to ‘REMOTE’ at step S470. Accordingly, when another process attempts access to the page later, it may use the data stored in the remote memory.

Conversely, when the data at the corresponding time is not stored in the remote memory at step S460, new memory is allocated for the first page (@old) at step S480, the memory block and the metadata are copied at step S490, and the state of the memory block of the first page (@old) is set to ‘INACTIVE’ at step S495. That is, it is placed in the inactive list in the LRU chain.

Because the data present in the inactive list is not mapped to processes, there is no need to perform additional mapping.

Meanwhile, the cases \textcircled{3} to \textcircled{5} in Table 1 indicate that the first page (@old) is not mapped to the process performing writing, so these cases may be processed through page fault handling.

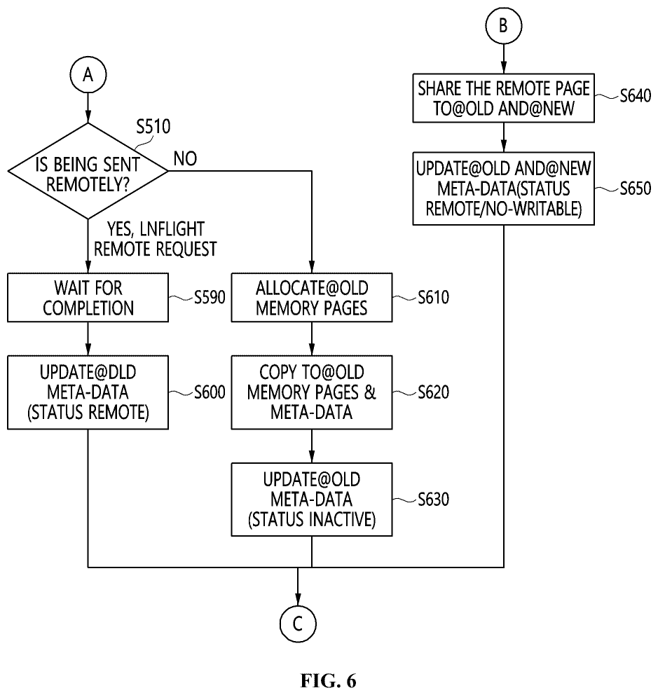

FIGS. 5 and 6 are flowcharts for explaining a method for processing copy-on-write for supporting a fork in a memory disaggregation system when a write page fault occurs according to an embodiment.

Referring to FIG. 5, when it is determined at step S510 that the first page (@old) is a block mapped only to additional processes other than the process performing writing (the case \textcircled{3} in Table 1), new memory is allocated to perform writing at step S520, the data of the existing process is copied, and the state for the memory disaggregation system is updated to ‘ACTIVE’ at step S530.

Subsequently, through page fault handling for the block of the second page (@new), write permission is assigned to the page table entry at step S540.

Here, because write protection is set also on the mappings of the additional processes, it is guaranteed that data is not altered while copying the data, and when the additional processes attempt to perform writing, the data is copied and used through the above-described mmu_notifier.

Meanwhile, when the first page (@old) is not mapped to any process at step S510 and is present in the local memory at step S550 (the case \textcircled{4} in Table 1), the block on which writing is to be performed may be write-protected and may be in an inactive state of the memory disaggregation system.

Here, if the corresponding block is present also in the remote memory and is valid therein at step S560, the write protection on the data in the local memory is removed, and the data is mapped to the second page (@new). Then, the metadata of the first page (@old) is set to ‘REMOTE’ such that, when the data is required later, the data is fetched from the remote memory and used.

However, when the corresponding block is being transferred to the remote memory at step S580, as illustrated in FIG. 6, the write protection on the data in the local memory is removed after waiting for completion of the transfer to the remote memory at step S590, and then the data is mapped to the second page (@new). Also, the metadata of the first page (@old) is set to ‘REMOTE’ at step S600 such that, when the data is required later, the data is fetched from the remote memory and used.

On the other hand, when the corresponding block is not present in the remote memory at step S560 and is not being transferred to the remote memory at step S580, new memory for the first page (@old) is allocated at step S610, the memory block and the metadata are copied at step S620, and pages for the new memory block are maintained in the inactive state. Then, the data in the local memory is mapped to the second page (@new), and the write protection is removed.

Finally, referring again to FIG. 5, when the first page (@old) is stored in the remote memory, rather than the local memory, at step S550 (the case \textcircled{5} in Table 1), the data in the remote memory is made to be shared between two pieces of disaggregated memory metadata (@old and @new) at step S640, as illustrated in FIG. 6.

Then, the shared data in the remote memory is made write-protected, and when a page fault occurs, the data should be copied to the local memory, after which sharing of the remote memory data should be discontinued at step S650.

Here, if the remote memory data is used only by a single piece of disaggregated memory metadata, it may retain ownership of the remote memory data even after the data is copied to the local memory.

After the remote memory data is shared as described above, both the first page (@old) and the second page (@new) become a remote state. Then, for the second page (@new), a procedure of fetching the data from the remote memory and mapping to the address space of the process is performed by page fault handling of the memory disaggregation system.

However, because fetching the data from the remote memory is time-consuming, when a page fault for the same block is caused by another process, the remote memory data may be shared among three or more pieces of disaggregated memory metadata.

As described above, the embodiment proposes a handling method for each of the multiple cases for CoW in the disaggregated memory environment based on two entry points.

Here, metadata management of the memory disaggregation system is important in implementation. In the embodiment, although each process may manage its metadata, the method of managing metadata for each page or block and sharing the metadata among multiple processes is used.

In the event of CoW, the metadata may be copied similarly to the page and may be managed separately. For example, through management of remote memory, the number of processes sharing the block may be determined using a process count. Here, the block is shared by multiple processes, but when the count becomes 1 because the process is terminated or another block is used due to CoW, a single process exclusively manages the remote memory of the corresponding block.

When a single process performs CoW based on such metadata in the state in which multiple processes share data stored in remote memory, there is an advantage in which metadata on the remote memory block is shared by the multiple processes and only the process performing writing copies the data to local memory and uses the same. As a result, in the memory disaggregation system, the complexity of CoW may be reduced, and the performance of CoW may be improved.

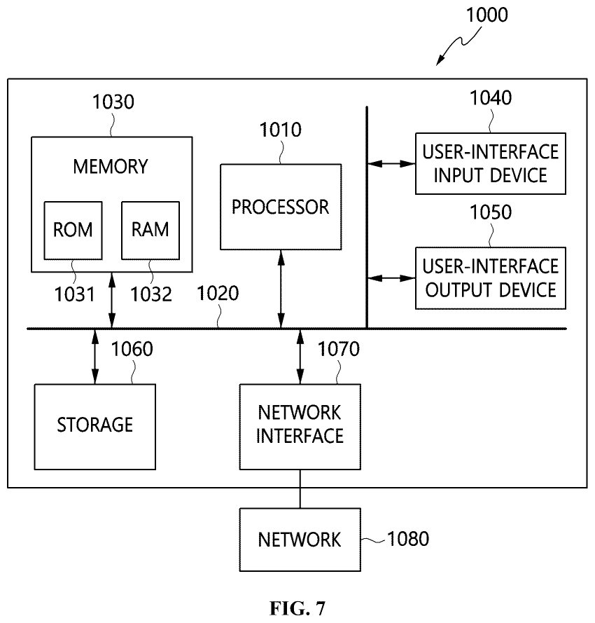

FIG. 7 is a view illustrating a computer system configuration according to an embodiment.

The apparatus for processing copy-on-write for supporting a fork in a memory disaggregation system according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected with a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

The apparatus for processing copy-on-write for supporting a fork in a memory disaggregation system according to this embodiment may perform fork processing in the system including disaggregated memory, which includes the local memory 100 and the remote memory 200, as illustrated in FIG. 2.

That is, when a child process is generated in the event of a fork, the apparatus for processing copy-on-write for supporting a fork in a memory disaggregation system according to the embodiment may copy a page table for the disaggregated memory of a parent process to the child process and set write protection on a page of the disaggregated memory, as illustrated in FIG. 2.

Also, the apparatus for processing copy-on-write for supporting a fork in a memory disaggregation system includes a first handler corresponding to access to a write-protected page mapped to a page table and a second handler corresponding to write access to a write-protected page that is not mapped to the page table, thereby processing the write access to the write-protected page, as described above with reference to FIGS. 3 to 6.

According to the disclosed embodiment, when a new process is forked in an application or container in a memory disaggregation system, Copy-on-Write (CoW) may be supported.

According to the disclosed embodiment, only metadata is shared for a block in remote memory, and actual data is fetched and used by only a process that performs writing. Therefore, performance may be improved, and complexity may be alleviated.

According to the disclosed embodiment, the latency of a fork may be reduced because not all pages are copied at once.

According to the disclosed embodiment, only a page in use (the page to which writing is performed) is copied, whereby memory waste may be reduced.

Specific implementations described in the present disclosure are embodiments and are not intended to limit the scope of the present disclosure. For conciseness of the specification, descriptions of conventional electronic components, control systems, software, and other functional aspects thereof may be omitted. Also, lines connecting components or connecting members illustrated in the drawings show functional connections and/or physical or circuit connections, and may be represented as various functional connections, physical connections, or circuit connections that are capable of replacing or being added to an actual device. Also, unless specific terms, such as “essential”, “important”, or the like, are used, the corresponding components may not be absolutely necessary.

Accordingly, the spirit of the present disclosure should not be construed as being limited to the above-described embodiments, and the entire scope of the appended claims and their equivalents should be understood as defining the scope and spirit of the present disclosure.

What is claimed is:

1. A method for processing copy-on-write for supporting a fork in a memory disaggregation system, comprising:
when a child process is generated in an event of a fork, processing the fork by copying a page table for disaggregated memory of a parent process to the child process and setting write protection on a page of the disaggregated memory; and
processing write access to the write-protected page,
wherein processing the write access uses at least one of a first handler corresponding to access to the write-protected page mapped to the page table, or a second handler corresponding to the write access to the write-protected page that is not mapped to the page table, or a combination thereof.

2. The method of claim 1, wherein the page of the disaggregated memory is set to an active state or an inactive state depending on whether the page is mapped to a process when the page is stored in local memory, and is set to a remote state when the page is stored in remote memory.

3. The method of claim 2, wherein processing the write access using the first handler comprises
when the write-protected page is mapped to a write access process and other processes, setting a page copied from the write-protected page to the active state, and
assigning write permission on the copied page to the write access process.

4. The method of claim 2, wherein
processing the write access using the first handler comprises
when the write-protected page is mapped only to a write access process, changing the write-protected page to the active state, and
assigning write permission on the write-protected page to the write access process, and
further comprises
when the write-protected page is stored also in the remote memory, changing the write-protected page stored in the remote memory to the remote state, and
when the write-protected page is stored only in the local memory, copying a page from the write-protected page and setting the copied page to the inactive state.

5. The method of claim 2, wherein processing the write access using the second handler comprises
when the write-protected page is mapped to a process other than a write access process, setting a page copied from the write-protected page to the active state, and
assigning write permission on the copied page to the write access process.

6. The method of claim 2, wherein
processing the write access using the second handler comprises
when the write-protected page is not mapped to any process and is stored in the local memory, changing the write-protected page to the active state, and
assigning write permission on the write-protected page to a write access process, and
further comprises
when the write-protected page is stored also in the remote memory, changing the write-protected page stored in the remote memory to the remote state, and
when the write-protected page is stored only in the local memory, copying a page from the write-protected page and setting the copied page to the inactive state.

7. The method of claim 2, wherein processing the write access using the second handler comprises
when the write-protected page is not mapped to any process and is stored in the remote memory, setting a page in the local memory that is copied from the write-protected page to the active state,
assigning write permission on the copied page to a write access process, and
setting the write-protected page stored in the remote memory to the remote state and setting write protection thereon.

8. An apparatus for processing copy-on-write for supporting a fork in a memory disaggregation system, comprising:
memory in which at least one program is recorded; and
a processor for executing the program,
wherein
when a child process is generated in an event of a fork, the program processes the fork by copying a page table for disaggregated memory of a parent process to the child process and setting write protection on a page of the disaggregated memory, and
when processing write access to the write-protected page, the program uses at least one of a first handler corresponding to access to the write-protected page mapped to the page table, or a second handler corresponding to the write access to the write-protected page that is not mapped to the page table, or a combination thereof.

9. The apparatus of claim 8, wherein
the page of the disaggregated memory is set to an active state or an inactive state depending on whether the page is mapped to a process when the page is stored in local memory, and is set to a remote state when the page is stored in remote memory.

10. The apparatus of claim 9, wherein
when the write-protected page is mapped to a write access process and other processes, the first handler sets a page copied from the write-protected page to the active state and assigns write permission on the copied page to the write access process.

11. The apparatus of claim 9, wherein
when the write-protected page is mapped only to a write access process, the first handler changes the write-protected page to the active state and assigns write permission on the write-protected page to the write access process,
when the write-protected page is stored also in the remote memory, the first handler changes the write-protected page stored in the remote memory to the remote state, and
when the write-protected page is stored only in the local memory, the first handler copies a page from the write-protected page and sets the copied page to the inactive state.

12. The apparatus of claim 9, wherein
when the write-protected page is mapped to a process other than a write access process, the second handler sets a page copied from the write-protected page to the active state and assigns write permission on the copied page to the write access process.

13. The apparatus of claim 9, wherein
when the write-protected page is not mapped to any process and is stored in the local memory, the second handler changes the write-protected page to the active state and assigns write permission on the write-protected page to a write access process,
when the write-protected page is stored also in the remote memory, the second handler changes the write-protected page stored in the remote memory to the remote state, and
when the write-protected page is stored only in the local memory, the second handler copies a page from the write-protected page and sets the copied page to the inactive state.

14. The apparatus of claim 9, wherein
when the write-protected page is not mapped to any process and is stored in the remote memory, the second handler sets a page in the local memory that is copied from the write-protected page to the active state, assigns write permission on the copied page to a write access process, sets the write-protected page stored in the remote memory to the remote state, and sets write protection thereon.
